(19) United States
(12) Patent Application Publication
(10) Pub. No.: US 2007/0137833 A1
(43) Pub. Date: Jun. 21, 2007

(54) Dual zone type air conditioner for vehicles

(76) Inventors: Sungho Kang, Daejeon-si (KR); Sangchul Byon, Daejeon-si (KR); Yongsang Kim, Daejeon-si (KR); Yongeun Seo, Daejeon-si (KR); Yuncheol Park, Daejeon-si (KR)

Correspondence Address: FULBRIGHT & JAWORSKI, LLP, 666 FIFTH AVE, NEW YORK, NY, 10103-3198, US

(21) Appl. No.: 11/640,659

(22) Filed: Dec. 18, 2006

(30) Foreign Application Priority Data
Dec. 19, 2005 (KR) 2005-125562

(51) Int. Cl. B60H 3/00; B60H 1/00

(52) U.S. Cl. 165/42; 165/202

(57) ABSTRACT

The present invention relates to a dual zone type air conditioner for vehicles, which can freely adjust the air volume supplied to the right and left sides of the inside of the vehicle by mounting a film door between an evaporator and a temp door, realize a perfect independent control by controlling temp doors in such a manner as to allow the temp door mounted at a larger air volume side to be opened smaller than the temp door mounted at a smaller air volume side according to a temperature difference between the right and left sides, minimize eccentricity in cooling effect of the evaporator by minimizing the eccentricity of the air passing through the evaporator, and minimize a load of a blower under a condition where the air volume of the driver's seat or the front passenger's seat is maximized.

### BACKGROUND OF THE INVENTION

1. Field of the Invention

This application claims priority from Korean Patent Application No. 2005-125562 filed Dec. 19,2005, incorporated herein by reference in its entirety.

The present invention relates to a dual zone type air conditioner for vehicles, and more particularly, to such a dual zone type air conditioner for vehicles, which can freely adjust the air volume supplied to right and left sides (i.e., driver's seat and front passenger's seat) of the inside of the vehicle by mounting a film door between an evaporator and a temp door, realize a perfect independent control by controlling temp doors in such a manner as to allow the temp door mounted at a larger air volume side to be opened smaller than the temp door mounted at a smaller air volume side according to a difference in temperature of the right and left sides, minimize eccentricity in cooling effect of the evaporator by minimizing the eccentricity of the air (air volume) passing through the evaporator, and minimize a load of a blower under a condition where the air volume of the driver's seat or the front passenger's seat is maximized.

2. Background Art

In general, an air conditioner for vehicles is a car interior component, which is installed in the vehicle heat for the purpose of cooling the inside of the vehicle in the summer season or the winter season or removing frost from a windshield in rainy season or winter season to thereby secure a driver's front and rear visual field. Since such an air conditioner typically includes a heating device and a cooling device together, so that it heats, cools or ventilates the inside of the vehicle through the steps of selectively introducing the indoor air or the outdoor air to the air conditioner through a blower unit, heating or cooling the introduced air, and blowing the heated or cooled air into the vehicle.

Such an air conditioner is classified into a three-piece type where a blower unit, an evaporator unit, and a heater core unit are disposed independently, a semi-center type where the evaporator unit and the heater core unit are embedded in an air-conditioning case and the blower unit is mounted separately, and a center-mounting type where the three units are all embedded in the air-conditioning case.

Meanwhile, recently, an independent-type air conditioner has been applied to a high-class vehicle. The dual zone type air conditioner for vehicles is a device for dividing the inside of the vehicle into two parts and separately performing air-conditioning for each part (for instance, a driver's seat side and a front passenger's seat side).

FIG. 1 is a sectional view showing an example of an independent-type air conditioner 1 for vehicles according to a prior art.

As shown in the drawing, The dual zone type air conditioner for vehicles 1 includes: an air-conditioning case 10 having an air passageway 12 formed therein; a partition wall 11 for partitioning the air passageway 12 into first and second air passageways 13 and 14; an evaporator 2 mounted on the upstream side of the air passageway 12; a heater core 3 mounted on the downstream side of the air passageway 12; and a blower 18 mounted on an air inflow port 10a of the air-conditioning case 10.

An indoor and outdoor air converting door 16 is mounted on the air inflow port 10a of the air-conditioning case 10 to selectively introduce the indoor air and the outdoor air thereto, and at least one mode door 17 is mounted on an air outflow port 10b formed on the downstream side of the first and second air passageways 13 and 14. In addition, two temp doors 15 are mounted on the first and second air passageways 13 and 14 in a direct upstream side of the heater core 3 to adjust the volume of the introduced air.

The conventional independent-type air conditioner 1 as constructed above adjusts the speeds of the temp doors 15 and the blower 18 to independently adjust the temperatures of the right and left sides, and in this instance, air volumes of the right and left sides are adjusted uniformly. That is, the temp doors 15 play the main role to adjust the temperatures of the right and left sides and the blower 18 plays an auxiliary role to provide the right and left sides with the uniform air volume.

Therefore, the indoor air or the outdoor air introduced by the blower 18 is selectively cooled while passing through the evaporator 2, and then, separately introduced into the first and second air passageways 13 and 14 by the partition wall 11. After that, the air is selectively heated by the heater core 3, and then, supplied to the left side or right side inside the vehicle through the air outflow port 10b formed on the downstream side of the air passageways 13 and 14 to partially heat or cool the inside of the vehicle.

A perfect independent-type air-conditioning system must independently adjust temperature, mode and air volume at the right and left sides. However, the air conditioner 1 according to the prior art cannot independently adjust the air volume introduced into the first and second air passageways 13 and 14 since one blower 18 is used and the air volume is separated into the right and left sides by the fixed partition wall 11, and so, the air conditioner 1 cannot realize the perfect independent-type air-conditioning system, which can adjust the air volume according to the inside states of the vehicle. For instance, since the air conditioner 1 discharges air even when there is no passenger on a front passenger's seat, it is not effective. Moreover, the air conditioner 1 provides a one-sided cooling effect of the evaporator 2 since there is no structure to correct a one-sided inclination of air volume passing through the evaporator 2 when the air passing through the evaporator 2 is inclined biasedly, whereby a passenger may feel a sense of unpleasantness.

Meanwhile, to solve the above problems, two blowers (not shown), which are independently operated, are mounted on the upstream side of the air passageway 12, and so, a relative air volume introduced into the first and second air passageways 13 and 14 can be controlled by adjusting the speeds of the two blowers.

However, the above air conditioner has several problems such as a rise of manufacturing costs, complication in structure, an increase of noise, and a frequently occurring errors, since the air conditioner must use the two blowers and requires a device for controlling motors of the blowers to adjust the air volume supplied to the right and left sides inside the vehicle. Furthermore, the above air conditioner has another problem in that durability is deteriorated due to a load occurring on the relevant blower when the maximum air volume is supplied to the right or left side inside the vehicle.

### SUMMARY OF THE INVENTION

Accordingly, the present invention has been made to solve the above-mentioned problems occurring in the prior arts, and it is an object of the present invention to provide a dual zone type air conditioner for vehicles, which can freely adjust the air volume supplied to the right and left sides (i.e., driver's seat and front passenger's seat) of the inside of the vehicle by mounting a film door between an evaporator and a temp door, realize a perfect independent control by controlling temp doors in such a manner as to allow the temp door mounted at a relatively larger air volume side to be opened smaller than the temp door mounted at a relatively smaller air volume side according to a temperature difference between the right and left sides, minimize eccentricity in cooling effect of the evaporator by minimizing the eccentricity of the air (air volume) passing through the evaporator, and minimize a load of a blower under a condition where the air volume of the driver's seat or the front passenger's seat is maximized.

To accomplish the above objects, according to the present invention, there is provided a dual zone type air conditioner for vehicles, which includes: an air-conditioning case having an air passageway formed therein; an evaporator and a heater core mounted on the air passageway of the air-conditioning case at a predetermined interval in order; a partition wall for partitioning the air passageway of the downstream side of the evaporator into a first air passageway and a second air passageway; and temp doors respectively mounted on the first and second air passageways between the evaporator and the heater core for adjusting temperature, The dual zone type air conditioner for vehicles comprising: a film door mounted between the evaporator and the temp doors for adjusting a relative air volume of the air, which flows in the first air passageway and the second air passageway, the film door having an air-passing hole formed in a direction to cross the first and second air passageways for varying a passageway sectional area of the first and second air passageways; and an drive means for driving the film door.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a sectional view showing a dual zone type air conditioner for vehicles according to a prior art;

FIGS. 2 to 4 are sectional views showing an air volume according to an operational state of a film door of a dual zone type air conditioner for vehicles according to the present invention;

FIG. 5 is a perspective view of the film door;

FIG. 6 is a graph showing an air volume distribution rate and a movement of a temp door according to a temperature difference between the right and left sides under a condition where the air conditioner is turned off; and

FIG. 7 is a graph showing an air volume distribution rate and a movement of a temp door according to a temperature difference between the right and left sides under a condition where the air conditioner is turned on.

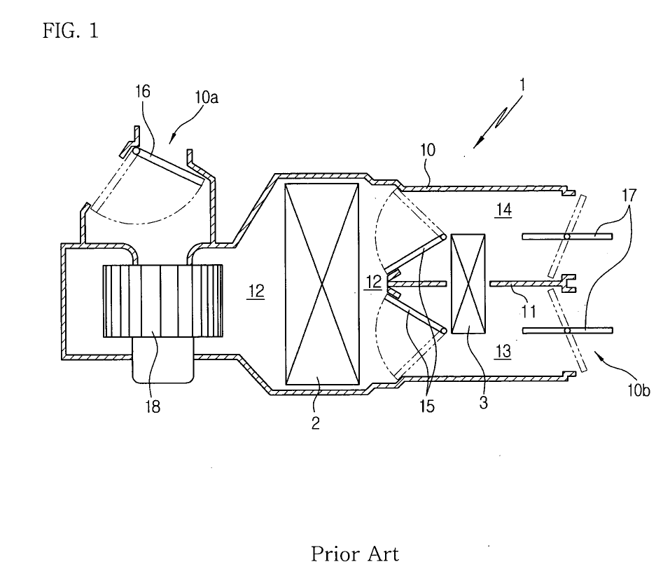

### DETAILED DESCRIPTION OF THE PREFERRED EMBODIMENT

Reference will be now made in detail to the preferred embodiment of the present invention with reference to the attached drawings.

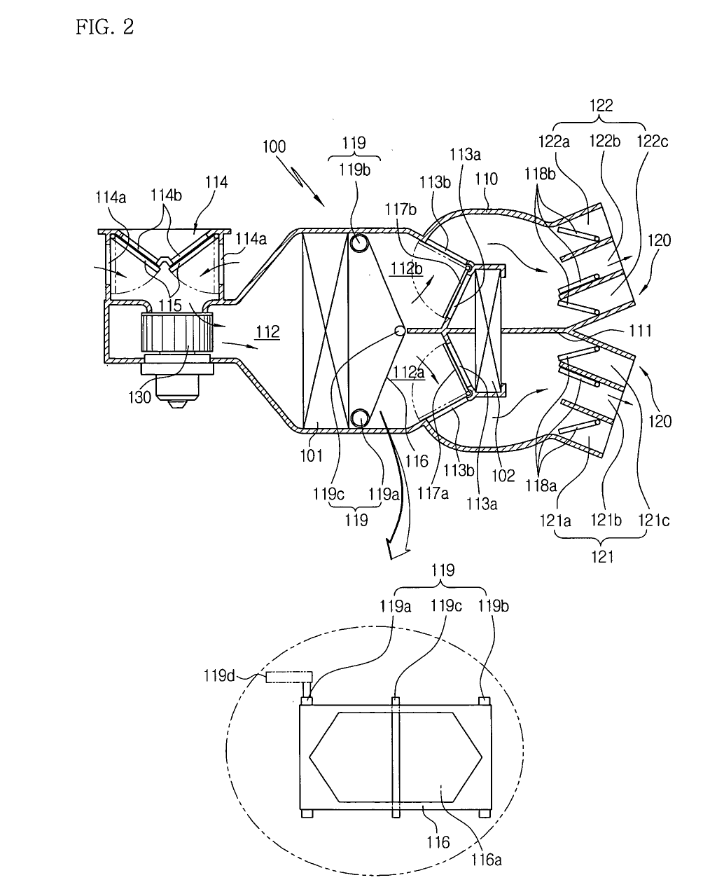

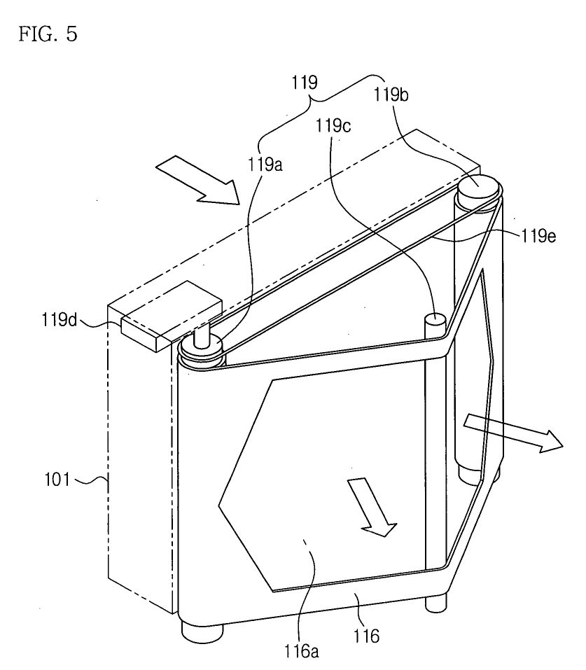

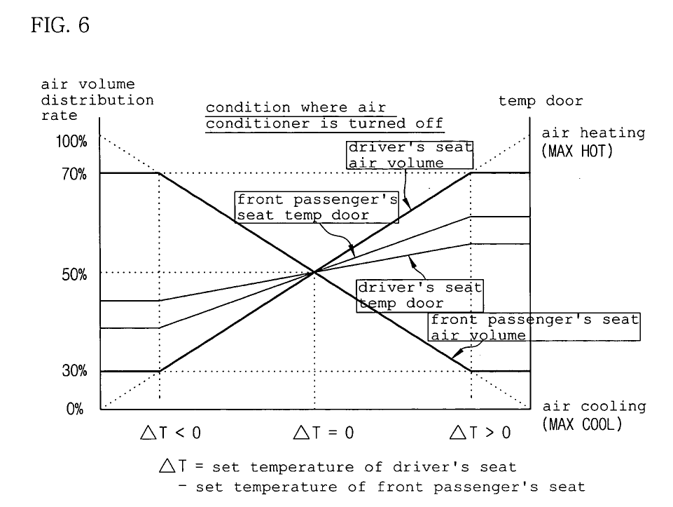

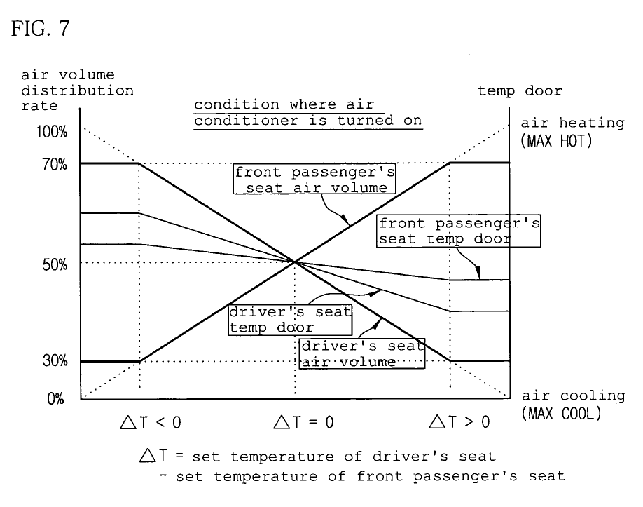

FIGS. 2 to 4 are sectional views showing an air volume according to an operational state of a film door of a dual zone type air conditioner for vehicles according to the present invention, FIG. 5 is a perspective view of the film door, FIG. 6 is a graph showing an air volume distribution rate and a movement of a temp door by a temperature difference between the right and left sides under a condition where the air conditioner is turned off, and FIG. 7 is a graph showing an air volume distribution rate and a movement of a temp door by a temperature difference between the right and left sides under a condition where the air conditioner is turned on.

As shown in the drawings, The dual zone type air conditioner for vehicles 100 according to the present invention includes an air-conditioning case 110 having an air passageway 112 formed therein. An air inflow port 114 is formed on the upstream side of the air passageway 112 of the air-conditioning case 110 and has an indoor air inflow hole 114a and an outdoor air inflow hole 114b, and an air outflow port 120 is formed on the downstream side of the air passageway 112.

The air outflow port 120 includes a left side air outflow port 121 and a right side air outflow port 122 divided by a partition wall 111, which will be described later, to independently supply hot air and cold air to the left side (driver's seat side) and the right side (front passenger's seat side) inside the vehicle.

Here, the left and right side air outflow ports 121 and 122 respectively include defrost vents 121a and 122a, face vents 121b and 122b, and floor vents 121c and 122c, and are fluidically communicated with vent holes (not shown) and ducts (not shown) formed inside the vehicle.

Additionally, mode doors 118a and 118b are rotatably mounted on the vents 121a to 121c and 122a to 122c to selectively open and close the vents 121a to 121c and 122a to 122c, whereby air-conditioning modes (a defrost mode, a face mode, a floor mode, a mix mode, and a bi-level mode) can be configured in the air conditioner 100.

In addition, a blower 130 is mounted on the upstream side of the air passageway 112 of the air-conditioning case 110 to forcedly introduce the indoor air or the outdoor air through the indoor air inflow hole 114a or the outdoor air inflow hole 114b. In this instance, the indoor and outdoor air inflow holes 114a and 114b are selectively opened and closed by an indoor and outdoor air converting door 115.

Moreover, an evaporator 101 and a heater core 102 are mounted on the air passageway 112 of the air-conditioning case 110 at a predetermined interval in order. The evaporator 101 and the heater core 102 are mounted between the blower 130 and the air outflow port 120 at the predetermined interval. Here, the heater core 102 is mounted in a direction to cross the first and second air passageways 112a and 112b.

The partition wall 111 is formed inside the air-conditioning case 110 to divide the downstream side air passageway 112 of the evaporator 101 into the right and left sides, namely, into a first air passageway 112a and a second air passageway 112b.

The front end portion of the upstream side of the partition wall 111 is spaced from the rear face of the evaporator 101 at a predetermined interval, and the rear end portion of the downstream side is formed on the air outflow port 120. So, the air passing through the evaporator 101 is divided into the right and left sides along the first and second air passageways 112a and 112b to the air outflow port 120 to be flown independently.

Here, it is preferable that sectional areas of the first and second air passageways 112a and 112b are the same.

Furthermore, temp doors 117a and 117b are respectively mounted on the first and second air passageways 112a and 112b between the evaporator 101 and the heater core 102 to adjust temperature by selectively inducing the air, which flows through the evaporator 101, to pass through or bypass the heater core 102.

That is, the two temp doors 117a and 117b respectively mounted on the first and second air passageways 112a and 112b located in front of the heater core 102 are operated to independently open and close an air passageway 113a passing through the heater core 102 and an air passageway 113b bypassing the heater core 102.

To adjust the volume of air flowing inside the first and second air passageways 112a and 112b after passing through the evaporator 101, between the evaporator 101 and the temp doors 117a and 117b, mounted are a film door 116 having an air-passing hole 116a formed in a direction to cross the first and second air passageways 112a and 112b to vary a passageway sectional area of the first and second air passageways 112a and 112b, and an drive means 119 for driving the film door 116.

The film door 116 laterally moves the air-passing hole 116a by the drive means 119 to adjust the volume of inflow air by relatively increasing and decreasing a sectional area of the upstream side of the first and second air passageways 112a and 112b and minimize eccentricity in a cooling effect of the evaporator 101 by minimizing eccentricity of the air (air volume) flowing to the first and second air passageways 112a and 112b after passing the evaporator 101. Of course, the first air passageway 112a or the second air passageway 112b may be entirely or partially opened or closed.

The drive means 119 includes: a driving roller 119a combined with one end portion of the film door 116 and rotatably mounted on one side of the air passageway 112 so to be rotated by an actuator 119d; a slave roller (119b) combined with the other end portion of the film door (116) and rotatably mounted on the other side of the air passageway (112), the slave roller being connected with the driving roller (119a) via a connection member (119e) so as to rotate in the same direction as that of the driving roller (119a); and a tension roller (119c) mounted between the driving roller (119a) and the slave roller (119b) for supporting the film door (116) to provide the film door (116) with a tension.

Here, the driving roller 119a and the slave roller 119b are connected with each other via a belt or a wire, which is the connection member 119e, in such a manner as to wind the film door 116 while rotating in the same direction during an operation of the actuator 119d.

In addition, the tension roller 119c is mounted biasedly in a downstream direction with respect to the driving roller 119a and the slave roller 119b to keep the tension of the film door 116 and to guide a flow of air by inclining the film door 116 in an air flow direction. Moreover, the tension roller 119c is mounted on the same line as the partition wall 111, and so, becomes a standard to divide air volumes of the right and left sides.

Therefore, when the driving roller 119a is rotated in a forward direction or a backward direction by the operation of the actuator 119d, the slave roller 119b connected with the driving roller 119a via the connection member 119e moves the air-passing hole 116a of the film door 116 to the left or the right while rotating forwardly and backwardly in the same direction as the driving roller 119a. In this instance, since the passageway sectional area of the first and second air passageways 112a and 112b is varied while relatively increasing or decreasing, the volume of air flowing to the first and second air passageways 112a and 112b can be controlled.

Furthermore, if the air-passing hole 116a of the film door 116 opens only one of the first and second air passageways 112a and 112b and closes the other one, wind which tends to flow toward the closed air passageway is smoothly guided and flows toward the opened air passageway side by an inclined side of the film door 116, which closes the air passageway.

Meanwhile, the temp doors 117a and 117b, the mode doors 118a and 118b and the indoor air and the outdoor air converting door 115 are also actuated by an actuator (not shown) or a cable (not shown) connected to a controlling part disposed on a manipulation panel of the inside of the vehicle.

Moreover, when the air conditioner is turned off, the film door 116 controls the temp door 117a or 117b mounted on one of the first and second air passageways 112a and 112b, which has a relatively larger air volume, to open the air passageway 113a passing through the heater core 102 smaller than the temp door 117a or 117b mounted on the other of the first and second air passageways 112a and 112b, which has a relatively smaller air volume.

Furthermore, when the air conditioner is turned on, the film door 116 controls the temp door 117a or 117b mounted on one of the first and second air passageways 112a and 112b, which has the relatively larger air volume, to open the air passageway 113b bypassing the heater core 102 smaller than the temp door 117a or 117b mounted on the other of the first and second air passageways 112a and 112b, which has the relatively smaller air volume. Here, to open the temp doors 117a and 117b small means a state where air volume passing through the relevant air passageway decreases.

That is, FIGS. 6 and 7 are graphs showing an air volume distribution rate and a movement of the temp doors according to a temperature difference between the right and left sides under conditions where the air conditioner is turned on and off. In the graphs, air cooling (MAX COOL) means the maximum cooling and a state where the temp doors 117a and 117b close the air passageway 113a passing the heater core 102 but open the air passageway 113b bypassing the heater core 102 to the maximum, and air heating (MAX HOT) means the maximum heating and a state where the temp doors 117a and 117b close the air passageway 113b bypassing the heater core 102 but open the air passageway 113a passing the heater core 102 to the maximum.

First, in FIG. 6, under the condition where the air conditioner is turned off, when temperature of the driver's seat is set to be higher than temperature of the front passenger's seat (ΔT>0), the air volume of the driver's seat side (for instance, driver's seat: 70%, front passenger's seat: 30%) is more than that of the front passenger's seat side but the temp door 117a of the driver's seat side is opened smaller than the temp door 117b of the front passenger's seat side.

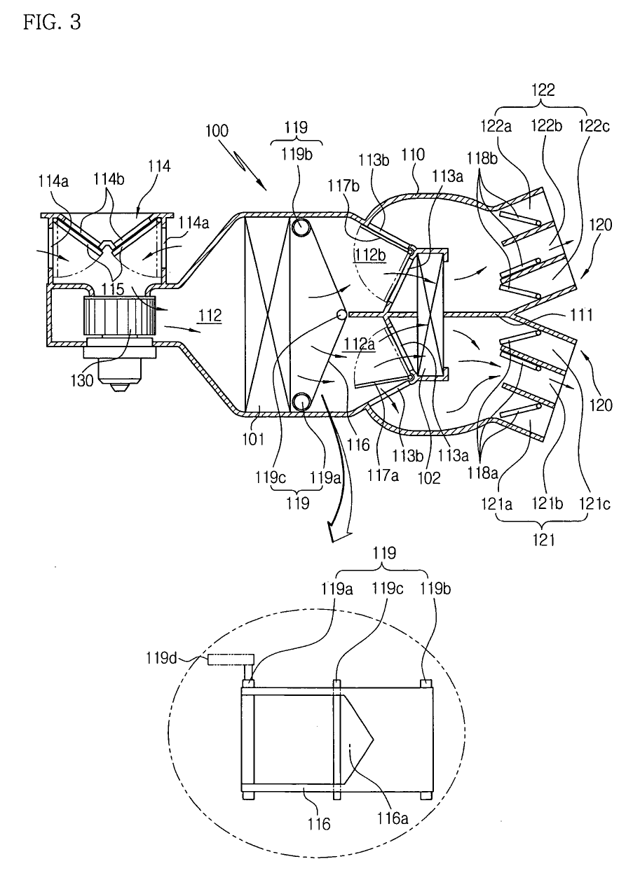

That is, the condition where the air conditioner is turned off is a heating mode. As shown in FIG. 3, all of the temp doors 117a and 117b of the driver's seat side and the front passenger's seat side open the air passageway 113a passing through the heater core 102 (increase of an opened amount). In this instance, if temperature of the driver's seat is set to be higher than that of the front passenger's seat, a relatively larger air volume is supplied to the driver's seat side (first air passageway), but the temp door 117a of the driver's seat side opens the air passageway 113a, which passes through the heater core 102, smaller than the temp door 117b of the front passenger's seat side.

Moreover, in FIG. 7, under the condition where the air conditioner is turned on, when temperature of the front passenger's seat is set to be lower than temperature of the driver's seat (ΔT>0), the air volume of the front passenger's seat side (for instance, front passenger's seat: 70%, driver's seat: 30%) is more than that of the driver's seat side but the temp door 117b of the front passenger's seat side is opened smaller than the temp door 117a of the driver's seat side.

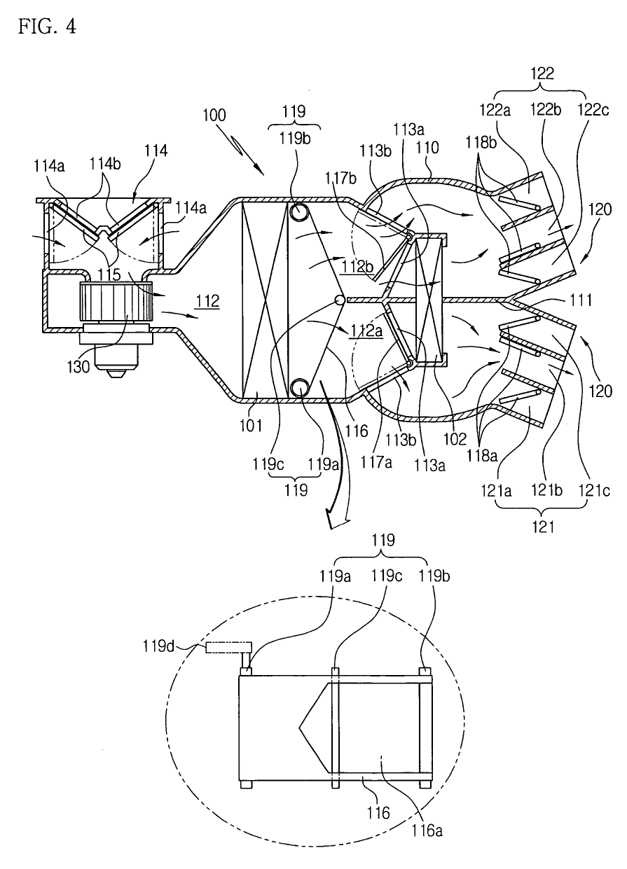

That is, the condition where the air conditioner is turned on is a cooling mode. As shown in FIG. 4, all of the temp doors 117a and 117b of the driver's seat side and the front passenger's seat side open the air passageway 113b bypassing the heater core 102 (increase of an opened volume). In this instance, if temperature of the front passenger's seat is set to be lower than that of the driver's seat, a relatively larger air volume is supplied to the front passenger's seat side (second air passageway), but the temp door 117b of the front passenger's seat side opens the air passageway 113b, which bypasses the heater core 102, smaller than the temp door 117a of the driver's seat side.

As described above, according to the present invention, the film door 116 adjusts opening of the first and second air passageways 112a and 112b to supply a large air volume to a place of a higher temperature, out of the driver's seat and the front passenger's seat, when the air conditioner is turned off, and to supply the large air volume to a place of a lower temperature, out of the driver's seat and the front passenger's seat, when the air conditioner is turned on.

So, the present invention can improve the passenger's agreeableness by relieving a change in temperature, which the passenger feels, according to a change in air volume.

Meanwhile, a load of the blower 130 can be minimized under a condition where the air volume of the driver's seat side or the front passenger's seat side becomes the greatest by the film door 116. For instance, when the driver wants to supply the air volume only to the driver's seat side (first air passageway), the air-passing hole 116a of the film door 116 is moved to the first air passageway 112a to completely close the upstream side of the second air passageway 112b of the front passenger's seat. So, since the entire air (air volume) passing through the evaporator 101 is supplied only to the driver's seat side, a large air volume can be obtained, and so, the same air volume as the prior art can be obtained even though the number of stage (speed) of the blower 130 is reduced.

Hereinafter, the operation of The dual zone type air conditioner for vehicles 110 will be described.

The air conditioner 100 according to the present invention can perform various air-conditioning modes (the defrost mode, the face mode, the floor mode, the mix mode, the bi-level mode and so on) according to the operational states of the indoor and outdoor air converting door 115, the temp doors 117a and 117b and the mode doors 118a and 118b. Since such air-conditioning modes are widely known, their detailed description will be omitted, and only operations according to the operational state of the film door 116, which is a characterized part of the present invention, will be described.

First, as shown in FIG. 2, if the air-passing hole 116a of the film door 116 is located on the first and second air passageways 112a and 112b in the same sectional area, equal air volumes are supplied to the driver's seat side (first air passageway) and the front passenger's seat side (second air passageway). That is, when the blower 130 is actuated, the air (indoor and outdoor air) selectively introduced by the indoor and outdoor air converting door 115 is selectively cooled while passing through the evaporator 101, and the air passing through the evaporator 101 is divided uniformly and flows toward the first and second air passageways 112a and 112b by the film door 116.

Continuously, the air flowing inside the first and second air passageways 112a and 112b is selectively heated while passing or bypassing the heater core 102 by the temp doors 117a and 117b, and then, flows toward the air outflow port 120. Finally, the air is discharged to the inside of the vehicle through the vents 121a to 121c and 122a to 122c opened by the mode doors 118a and 118b.

Next, as shown in FIG. 3, when the sectional area of the upstream side of the first air passageway 112a becomes larger than that of the second air passageway 112b while the air-passing hole 116a of the film door 116 is moved toward the first air passageway 122a, a relatively larger air volume is supplied to the driver's seat side (first air passageway) rather than the front passenger's seat side (second air passageway). That is, when the blower 130 is actuated, the air (indoor and outdoor air) selectively introduced by the indoor and outdoor air converting door 115 is selectively cooled while passing through the evaporator 101, and a relatively larger volume of the air passing through the evaporator 101 is introduced into the first air passageway 112a but a relatively smaller air volume is introduced into the second air passageway 112b by the film door 116.

Continuously, the air flowing inside the first and second air passageways 112a and 112b is selectively heated while passing or bypassing the heater core 102 by the temp doors 117a and 117b, and in this instance, according to a difference in temperature setting values of the driver's seat and the front passenger's seat, the temp door 117a mounted on the first air passageway 112a, which has the relatively larger air volume, is opened smaller than the temp door 117b mounted on the second air passageway 112b. After that, the air selectively passing through the heater core 102 flows toward the air outflow port 120, and finally, is discharged to the inside of the vehicle through the vents 121a to 121c and 122a to 122c opened by the mode doors 118a and 118b.

Next, as shown in FIG. 4, when the sectional area of the upstream side of the second air passageway 112b becomes larger than that of the first air passageway 112a while the air-passing hole 116a of the film door 116 is moved toward the second air passageway 122b, a relatively larger air volume is supplied to the front passenger's seat side (second air passageway) rather than the driver's seat side (first air passageway). That is, when the blower 130 is actuated, the air (indoor and outdoor air) selectively introduced by the indoor and outdoor air converting door 115 is selectively cooled while passing through the evaporator 101, and so, a relatively larger volume of the air passing through the evaporator 101 is introduced into the second air passageway 112b but a relatively smaller volume of the air is introduced into the first air passageway 112a by the film door 116.

Continuously, the air flowing inside the first and second air passageways 112a and 112b is selectively heated while passing or bypassing the heater core 102 by the temp doors 117a and 117b, and in this instance, according to a difference in temperature setting values of the driver's seat and the front passenger's seat, the temp door 117b mounted on the second air passageway 112b, which has the relatively larger air volume, is opened smaller than the temp door 117a mounted on the first air passageway 112a. After that, the air selectively passing through the heater core 102 flows toward the air outflow port 120, and finally, is discharged to the inside of the vehicle through the vents 121a to 121c and 122a to 122c opened by the mode doors 118a and 118b.

As described above, The dual zone type air conditioner for vehicles according to the present invention can freely adjust the air volume supplied to the right and left sides (driver's seat and front passenger's seat) of the inside of the vehicle by mounting a film door between an evaporator and a temp door, realize a perfect independent control by controlling temp doors in such a manner as to allow the temp door mounted at a relatively larger air volume side to be opened smaller than the temp door mounted at a relatively smaller air volume side according to a temperature difference between the right and left sides, minimize eccentricity in cooling effect of the evaporator by minimizing the eccentricity of the air (air volume) passing through the evaporator, and minimize a load of a blower under a condition where the air volume of the driver's seat or the front passenger's seat is maximized.

In addition, wind of an outlet of the evaporator can be smoothly guided toward the first and second air passageways since the tension roller is eccentrically mounted more downwardly than the driving roller and the slave roller and the film door is inclinedly mounted in the air volume direction.

Moreover, the present invention can achieve a miniaturization of the air conditioner by raising a space utilization rate since the film door, which slides for adjusting the air volume of the right and left sides is mounted between the evaporator and the temp doors.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A dual zone type air conditioner for vehicles, which includes: an air-conditioning case having an air passageway formed therein; an evaporator and a heater core mounted on the air passageway of the air-conditioning case at a predetermined interval in order; a partition wall for partitioning the air passageway of the downstream side of the evaporator into a first air passageway and a second air passageway; and temp doors respectively mounted on the first and second air passageways between the evaporator and the heater core for adjusting temperature, The dual zone type air conditioner for vehicles comprising:
a film door mounted between the evaporator and the temp doors for adjusting a relative air volume of the air, which flows in the first air passageway and the second air passageway, the film door having an air-passing hole formed in a direction to cross the first and second air passageways for varying a passageway sectional area of the first and second air passageways; and
a drive means for driving the film door.

2. The dual zone type air conditioner for vehicles according to claim 1, wherein the drive means includes:
a driving roller combined with one end portion of the film door and rotatably mounted on one side of the air passageway so to be rotated by an actuator;
a slave roller combined with the other end portion of the film door and rotatably mounted on the other side of the air passageway, the slave roller being connected with the driving roller via a connection member so as to rotate in the same direction as that of the driving roller; and
a tension roller mounted between the driving roller and the slave roller for supporting the film door to provide the film door with a tension.

3. The dual zone type air conditioner for vehicles according to claim 2, wherein the tension roller is mounted biasedly in a downstream direction with respect to the driving roller and the slave roller to guide a flow of air.

4. The dual zone type air conditioner for vehicles according to claim 1, wherein when the air conditioner is turned off, the film door controls the temp door mounted on one of the first and second air passageways, which has a relatively larger air volume, to open an air passageway passing through the heater core smaller than the temp door mounted on the other of the first and second air passageways, which has a relatively smaller air volume.

5. The dual zone type air conditioner for vehicles according to claim 1, wherein when the air conditioner is turned on, the film door controls the temp door mounted on one of the first and second air passageways, which has a relatively larger air volume, to open an air passageway bypassing the heater core smaller than the temp door mounted on the other of the first and second air passageways, which has a relatively smaller air volume.

6. The dual zone type air conditioner for vehicles according to claim 1, wherein when the air conditioner is turned off, the film door adjusts opening of the first and second air passageways to supply a large air volume to a place of a higher temperature, out of a driver's seat and a front passenger's seat.

7. The dual zone type air conditioner for vehicles according to claim 1, wherein when the air conditioner is turned on, the film door adjusts opening of the first and second air passageways to supply a large air volume to a place of a lower temperature, out of the driver's seat and the front passenger's seat.
